(19) United States
(12) Patent Application Publication
(10) Pub. No.: US 2009/0111624 A1
(43) Pub. Date: Apr. 30, 2009

(54) FRONT SPEED CHANGE DEVICE

(76) Inventor: Douglas Chiang, Taichung Hsien (TW)

Correspondence Address: Chien-Hui Su, P. O. Box 70-121 Taichung, Taichung City, 40899, TW

(21) Appl. No.: 11/930,096

(22) Filed: Oct. 31, 2007

(51) Int. Cl. F16H 63/00; F16H 59/00

(52) U.S. Cl. 474/80

(57) ABSTRACT

A front speed change device comprises a base, a first linking rod, a second linking rod and a chain guide unit. The body serves to fix the body to a seat tube. The first linking rod has one end pivoted to the base and another end thereof is pivoted to the chain guide unit. The second linking rod has one end pivoted to the base and another end thereof is pivoted to the chain guide unit. The chain guide unit includes an outer guide sheet and an inner guide sheet. Two ends of the outer guide sheet are connected to the two ends of the inner guide sheet. A receiving body is formed therebetween for receiving a chain; and the outer guide sheet is formed with a first end surface, a second end surface, a third end surface and a fouth end surface.

### FIELD OF THE INVENTION

The present invention relates to derailleur, and particularly to a front speed change device which has a greater rigidity without any interference. Thus no wear and no noise generate in speed change.

### BACKGROUND OF THE INVENTION

In U.S. Pat. No. 7,081,058, a bicycle front derailleur is disclosed. The derailleur comprises a base member configured to be coupled to a bicycle frame; a movable member having a front end, a rear end and a chain guide portion configured to be moved between first and second positions; a first link member including a first coupling portion pivotally coupled to said base member and a second coupling portion pivotally coupled to said movable member about a first pivot axis, said first coupling portion of said first link having a first forwardmost surface and a first rearwardmost surface, and said second coupling portion of said first link having a second forwardmost surface and a second rearwardmost surface; a second link member including a first coupling portion pivotally coupled to said base member and a second coupling portion pivotally coupled to said movable member about a second pivot axis; and a biasing member disposed on said first pivot axis to normally bias said movable member to said first position relative to said base member, said biasing member being at least partially located in front of said first forwardmost surface of said first coupling portion of said first link member relative to said movable member when said front derailleur is mounted to the bicycle frame in a normal operating position, and said biasing member being located completely in front of said second forward most surface of said second coupling portion of said first link relative to said movable member when said front derailleur is mounted to the bicycle frame in the normal operating position, the normal operating position being defined as a position where said chain guide portion extends longitudinally on a right side of the bicycle frame such that the front end of said movable member is located closer to a handlebar mounting portion of the frame than the rear end of said movable member, said first and second forwardmost surfaces facing substantially forward toward the handlebar mounting portion of the frame and said first and second rearwardmost surfaces facing substantially rearwardly away from the handlebar mounting portion of the frame when said front derailleur is mounted to the bicycle frame in the normal operating position. Although the prior art derailleur can increase the rigidity of the structure with a reduced stress and deformation. However, when the chain is engaged to a small teethed ring and a small size sprocket, the chain is shifted so that the chain will interfere the derailleur. Thus noise generates and the derailleur will wear.

In treading a bicycle, the chain suffers from a great extension. In change of speed, when the chain changes to different engagement, the derailleur will suffer from a great stress. Thus there is a demand for a novel design which can improve all above said defects.

### SUMMARY OF THE INVENTION

Accordingly, the primary object of the present invention is to provide a front speed change device, wherein has a greater rigidity without any interference. Thus no wear and no noise generate in speed change.

To achieve above objects, the present invention provides a front speed change device, comprising: a body includes a base, a first linking rod, a second linking rod and a chain guide unit; wherein the body serves to fix the body to a seat tube; the first linking rod has one end pivoted to the base and another end thereof is pivoted to the chain guide unit; the second linking rod has one end pivoted to the base and another end thereof is pivoted to the chain guide unit; the chain guide unit includes an outer guide sheet and an inner guide sheet; two ends of the outer guide sheet are connected to the two ends of the inner guide sheet; a receiving body is formed between the outer guide sheet and the inner guide sheet for receiving a chain; the outer guide sheet is formed with a first end surface, a second end surface, and a third end surface; and the first end surface is at a front end of the chain guide unit; the second end surface is at a lower side of the first end surface and behind a front part of the first end surface; and is reduced from and parallel to the first end surface; the third end surface is connected to the second end surface; the fourth end surface is connected to the teethed ring set; the second end surface expanded from the first end surface to a rear side thereof; the inner guide sheet 442 is a straight surface.

The various objects and advantages of the present invention will be more readily understood from the following detailed description when read in conjunction with the appended drawing.

### BRIEF DESCRIPTION OF THE DRAWINGS

FIG. 1 is a front schematic view of the front speed change device of the present invention.

FIG. 2 is a schematic view showing the relation of the front speed change device, chain, teethed ring set and the sprocket set in the present invention.

FIG. 3 is a schematic perspective view about the front speed change device of the present invention.

FIG. 4 shows a schematic view about line AB of FIG. 3.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

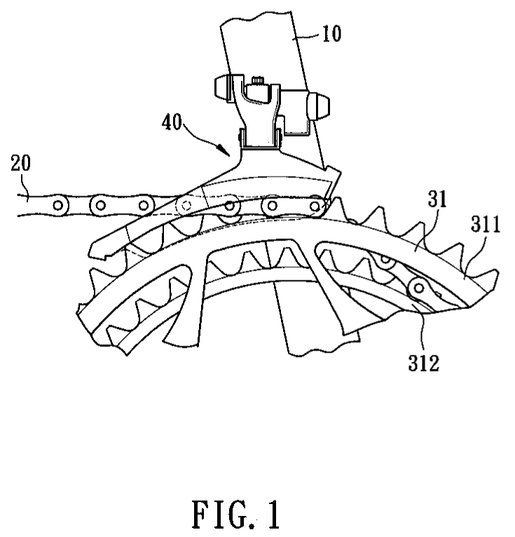

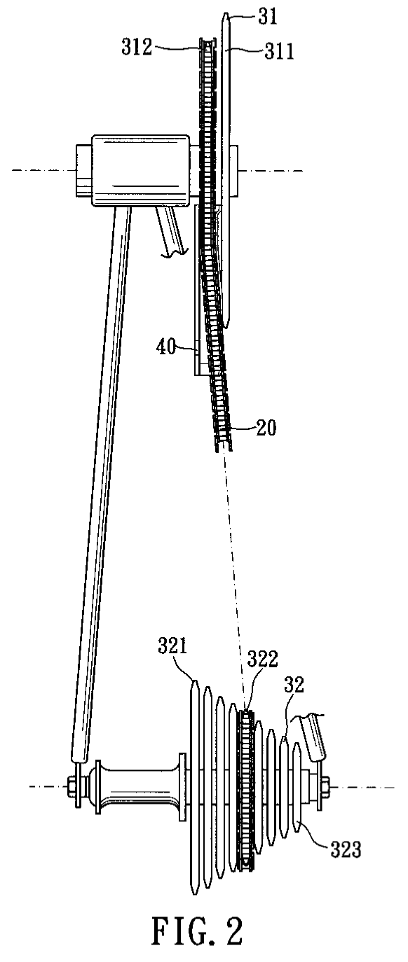

Referring to FIGS. 1 and 2, it is illustrated that the body 40 is installed to a lower side of the seat tube 10. The chain 20 passes through the body 40 so as to control the chain 20 to a large teethed ring 311 or to a small teethed ring 312. Referring to FIG. 2, in driving the driver treads upon the teethed ring set 31. The power is transferred to the sprocket set 32 so as to drive a bicycle to move forwards. A front side is defined as a direction that a moving forward direction as the teethed ring set 31 drives the chain 20. The opposite direction is defined as a rear side. When moving in high speed or low speed in moving upwards, a front speed change device or a rear speed change device (not shown) are used to adjust the position of the chain 20 in the teethed ring set 31 or the sprocket set 32. The power can be saved by the engagements of the large teethed ring 311 or the small teethed ring 312 with the large size sprocket 321 or the small size sprocket 323. When the chain 20 is at the small teethed ring 312 and the small size sprocket 323, the chain 20 is shifted instead of being straight so as to generate interference or noise. However, the prior art structure cannot overcome this problem. Thereby a novel design for overcoming such a problem is needed.

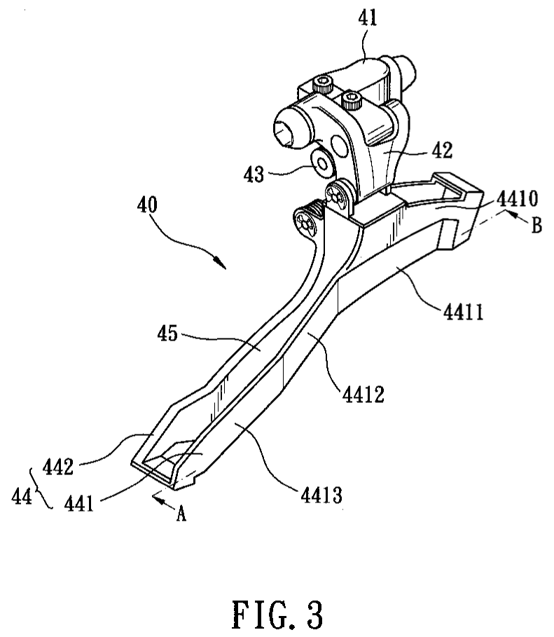

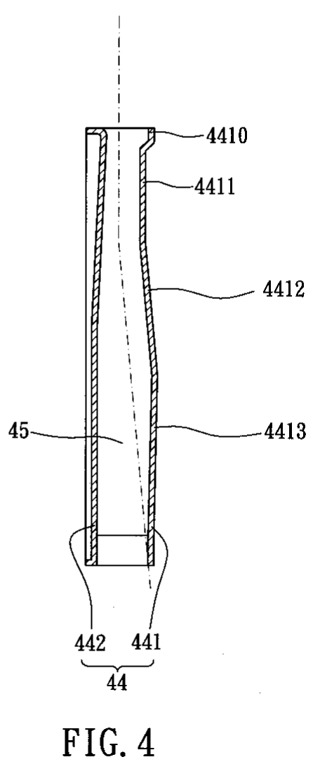

Referring to FIGS. 3 and 4, the front speed change device of the present invention is illustrated. The present invention has the following elements.

A body 40 includes a base 41, a first linking rod 42, a second linking rod 43 and a chain guide unit 44.

The body 40 serves to fix the body 40 to a seat tube 10.

The first linking rod 42 has one end pivoted to the base 41 and another end thereof is pivoted to the chain guide unit 44.

The second linking rod 43 has one end pivoted to the base 41 and another end thereof is pivoted to the chain guide unit 44.

The chain guide unit 44 includes an outer guide sheet 441 and an inner guide sheet 442. Two ends of the outer guide sheet 441 are connected to the two ends of the inner guide sheet 442. A receiving body 45 is formed between the outer guide sheet 441 and the inner guide sheet 442 for receiving a chain 20. The outer guide sheet 441 is formed with a first end surface 4410, a second end surface 4411, a third end surface 4412 and a fourth end surface 4413. The first end surface 4410 is at a front end of the chain guide unit 44. The second end surface 4411 is at a lower side of the first end surface 4410 and is reduced from and parallel to the first end surface 4410. The third end surface 4412 is connected to the second end surface 4411. The second end surface 4411 expanded from the first end surface 4410 to the fourth end surface 4413 so that the second end surface 4411 is formed as an inclined surface. The outer guide sheet 441 is made of aluminum alloy or carbon fiber so as to have a strong structure. The inner guide sheet 442 is a straight surface as illustrated in FIG. 4.

In the present invention, the base 41, first linking rod 42, second linking rod 43 and chain guide unit 44 are formed as a four linking structure. When the speed is changed to a lower value, the second end surface 4411 of the outer guide sheet 441 will be in contact with and resist against with the chain 20. Generally, the pitch of the chain 20 is about 1 centimeter. When a width of the outer chain plate with the inner chain plate is three times of the pitch, it is preferable to assure that the second end surface 4411 will in contact with the outer guide sheet 441. Thus it is preferable that the second end surface 4411 has a length about 1 to 3 centimeters. The third end surface 4412 will guide the chain 20 to move inwards. The chain 20 can be changed from the large teethed ring 311 to the small teethed ring 312 successfully. When the chain 20 is at the small teethed ring 312 or the small size sprocket 323, the chain 20 is shifted at a maximum value. The second end surface 4411 is parallel to the chain 20 at this state so as to assure that no interference generates and thus no wear generates. However, the length of the second end surface 4411 is limited, preferably to be between 2 to 5 centimeters so as to avoid the chain guide unit 44 to hurt the crank or ankle of the driver.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A front speed change device, comprising:
a body including a base, a first linking rod, a second linking rod and a chain guide unit; wherein
the base serves to fix the body to a seat tube;
the first linking rod has one end pivoted to the base and another end thereof is pivoted to the chain guide unit;.
the second linking rod has one end pivoted to the base and another end thereof is pivoted to the chain guide unit;
the chain guide unit includes an outer guide sheet and an inner guide sheet; two ends of the outer guide sheet are connected to the two ends of the inner guide sheet; a receiving body is formed between the outer guide sheet and the inner guide sheet for receiving a chain; the outer guide sheet is formed with a first end surface, a second end surface, and a third end surface; and
the first end surface is at a front end of the chain guide unit; the second end surface is at a lower side of the first end surface and behind a front part of the first end surface; and is reduced from and parallel to the first end surface; the third end surface is connected to the second end surface; the third end surface expands from the second end surface to a rear side thereof; and the inner guide sheet is a straight surface.

2. The front speed change device as claimed in claim 1, wherein a length of the second end surface is between 1 to 3 centimeters.

3. The front speed change device as claimed in claim 1, wherein a length of the third end surface is between 2 to 5 centimeters.

4. The front speed change device as claimed in claim 1, wherein the outer guide sheet further comprises a fourth end surface, the fourth end surface is connected to the teethed ring set; the third end surface expands from the second end surface to the fourth end surface so that the second end surface is formed as an inclined surface.

5. The front speed change device as claimed in claim 1, wherein the outer guide sheet is made of one of aluminum alloy and carbon fiber.

6. A front speed change device, comprising;
a chain guide unit including an outer guide sheet and an inner guide sheet; two ends of the outer guide sheet being connected to the two ends of the inner guide sheet; a receiving body being formed between the outer guide sheet and the inner guide sheet for receiving a chain; the outer guide sheet being formed with a first end surface, a second end surface, and a third end surface; and
the first end surface being at a front end of the chain guide unit; the second end surface being at a lower side of the first end surface and behind a front part of the first end surface; and being reduced from and parallel to the first end surface; the third end surface being connected to the second end surface; the third end surface expanding from the second end surface to a rear side thereof; the inner guide sheet being a straight surface.

7. The front speed change device as claimed in claim 6, wherein a length of the second end surface is between 1 to 3 centimeters.

8. The front speed change device as claimed in claim 6, wherein a length of the third end surface is between 2 to 5 centimeters.

9. The front speed change device as claimed in claim 6, wherein the outer guide sheet further comprises a fourth end surface, the third end surface expands from the second end surface to the fourth end surface so that the second end surface is formed as an inclined surface.

10. The front speed change device as claimed in claim 6, wherein the outer guide sheet is made of one of aluminum alloy and carbon fiber.
